(19) United States
(12) Patent Application Publication
(10) Pub. No.: US 2026/0274352 A1
(43) Pub. Date: Sep. 17, 2026

(54) TONNEAU COVER ASSEMBLY FOR A CONVERTIBLE

(71) Applicant: Clinton Smiley, South Holland, IL (US)

(72) Inventor: Clinton Smiley, South Holland, IL (US)

(21) Appl. No.: 19/081,238

(22) Filed: Mar. 17, 2025

(51) Int. Cl. B62D 35/00; B60J 7/12

(52) U.S. Cl. CPC B62D 35/007; B60J 7/12

(57) ABSTRACT

A tonneau cover assembly for a convertible includes a base panel, a pair of speed humps, and a center cover. The base panel is designed to detachably couple to mounting holes in a convertible. Each of the speed humps is coupled to the base panel. Each of the speed humps is designed to extend over a respective one of the back seats of the convertible between a respective one of the front seats of the convertible and a retractable roof of the convertible. The center cover is coupled to the base panel between the speed humps.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) the Names of the Parties to a Joint Research Agreement

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to covers for convertibles and more particularly pertains to a new tonneau cover assembly for convertibles. In convertibles, such as roadsters or cabriolet vehicles with a retractable or collapsible or removable roof, the back seats are small and rarely used. The new tonneau cover assembly is a customizable cover for the back seats that improves the aesthetics of the convertible without interfering with the operation of the retractable roof. The retractable roof can be extended and retracted without having to remove the new tonneau cover assembly.

### (2) Description of Related Art Including Information Disclosed Under 37 CFR 1.97 and 1.98

The prior art relates to covers for convertibles. The prior art, as best understood, does not disclose a tonneau cover assembly for a convertible that includes a base panel, a pair of speed humps, and a center cover, wherein the base panel is detachably coupled to mounting holes in the convertible and the speed humps are coupled to the base panel, and wherein each of the speed humps is designed to extend over a respective one of the back seats of the convertible between a respective one of the front seats of the convertible and a retractable roof of the convertible, such that the speed humps do not interfere with the operation of the retractable roof.

### (h) BRIEF SUMMARY OF THE INVENTION

An embodiment of the disclosure meets the needs presented above in a tonneau cover assembly for a convertible generally comprising a base panel, a pair of speed humps, and a center cover. The base panel is designed to detachably couple to mounting holes in a convertible. Each of the speed humps is coupled to the base panel. Each of the speed humps is designed to extend over a respective one of the back seats of the convertible between a respective one of the front seats of the convertible and a retractable roof of the convertible. The center cover is coupled to the base panel between the speed humps.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a tonneau cover assembly according to an embodiment of the disclosure.

FIG. 2 is a side view of an embodiment of the disclosure in use.

FIG. 3 is an exploded front view of an embodiment of the disclosure.

FIG. 4 is a side view of a component of an embodiment of the disclosure.

FIG. 5 is a bottom view of the component of an embodiment of the disclosure in FIG. 4.

FIG. 6 is a top view of a component of an embodiment of the disclosure.

FIG. 7 is a side view of the component of an embodiment of the disclosure in FIG. 6.

FIG. 8 is a top view of an embodiment of the disclosure.

FIG. 9 is a front view of a component of an embodiment of the disclosure.

### (j) DETAILED DESCRIPTION OF THE INVENTION

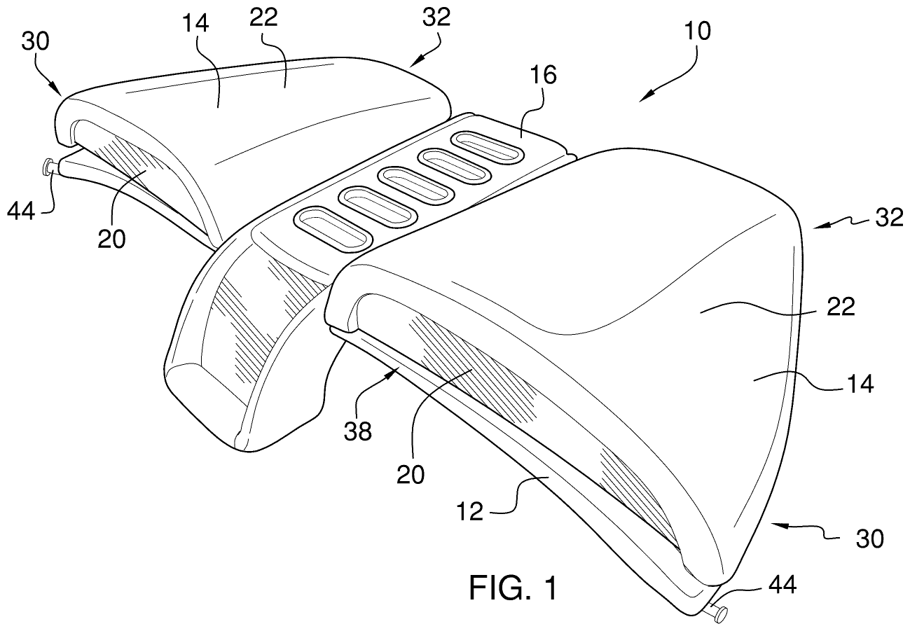

With reference now to the drawings, and in particular to FIGS. 1 through 9 thereof, a new tonneau cover assembly embodying the principles and concepts of an embodiment of the disclosure and generally designated by the reference numeral 10 will be described.

As best illustrated in FIGS. 1 through 9, the tonneau cover assembly 10 for a convertible 60 generally comprises a base panel 12, a pair of speed humps 14, and a center cover 16. The base panel 12 is designed to detachably couple to mounting holes in the convertible 60. Each of the speed humps 14 is coupled to the base panel 12. Each of the speed humps 14 is designed to extend over a respective one of the back seats 62 of the convertible 60 between a respective one of the front seats 64 of the convertible 60 and a retractable roof 66 of the convertible 60. The center cover 16 is coupled to the base panel 12 between the speed humps 14.

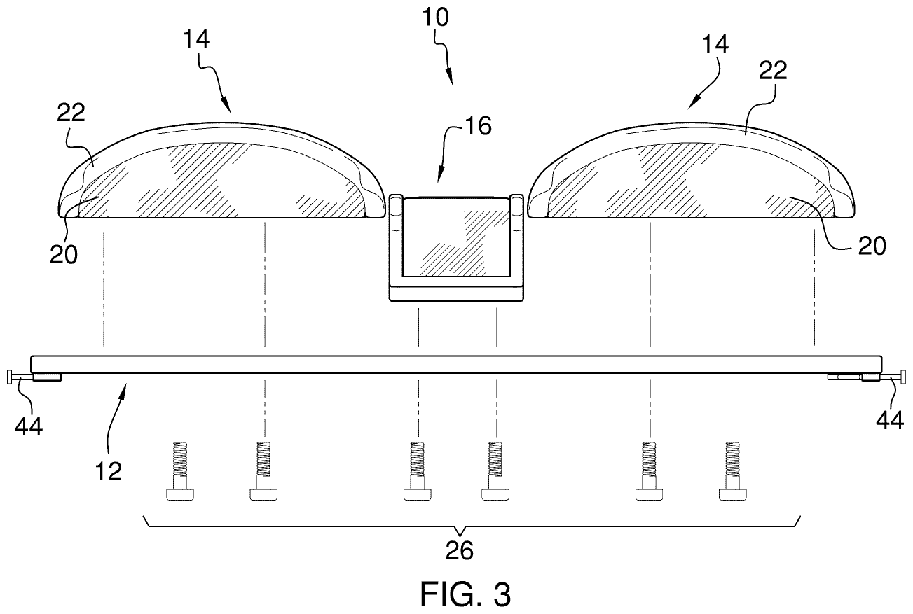

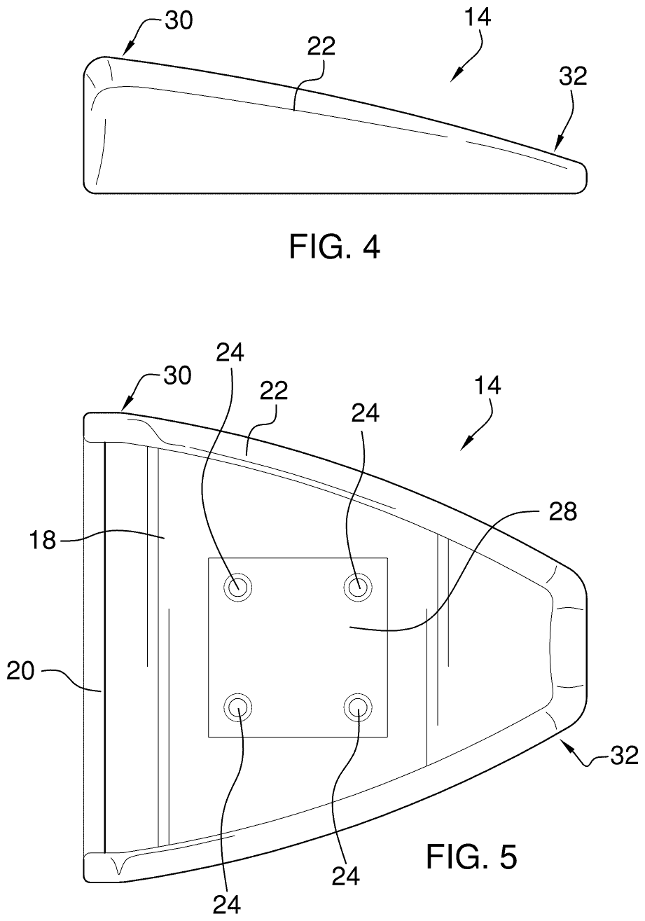

Each of the speed humps 14 is detachably coupled to the base panel 12. Each of the speed humps 14 includes a bottom panel 18, a front panel 20, and an aerodynamic shell 22 extending from the front panel 20 and over the bottom panel 18. The aerodynamic shell 22 is in the form of an arch extending over the front panel 20 and the bottom panel 18. The detachable design allows for customization as a user or installer can replace the speed humps 14 with other ones of a different design. In the exemplary embodiment in FIGS. 3 and 4, the bottom panel 18 of each of the speed humps 14 includes a plurality of orifices 24 designed to receive connecting elements 26 to detachably couple each of the speed humps 14 to the base panel 12. In this exemplary embodiment, the connecting elements 26 are threaded bolts and the orifices 24 are threaded openings in a support plate 28 mounted to or integrally formed in the base panel 12 of each of the speed humps 14. However, this is only one exemplary embodiment, and other connections, such as screws or snap fit connectors of any number or location, could be used.

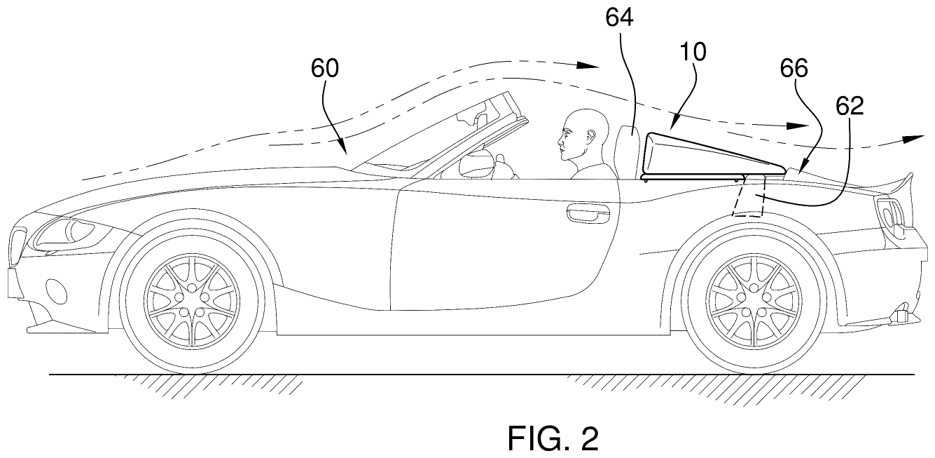

In the exemplary embodiment in FIGS. 4 and 5, the aerodynamic shell 22 tapers in height from a front shell portion 30 about the front panel 20 to a tail shell portion 32. In addition, the aerodynamic shell 22 tapers in width from the front shell portion 30 about the front panel 20 to the tail shell portion 32. The aerodynamic shell 22, as shown in FIG. 2, is designed to improve air flow as is well known in the automobile industry. The tapered design provides a smooth transition to the rear of the convertible 60. Other shapes of the aerodynamic shell 22 well known in the automobile industry are within the scope of the disclosure.

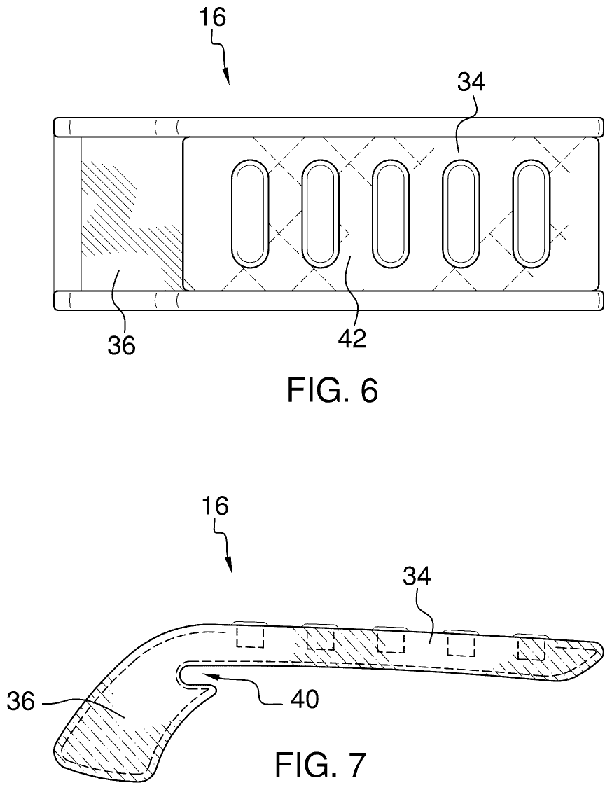

The center cover 16 has a console-like appearance. The center cover 16 includes a first cover portion 34 and a second cover portion 36. The first cover portion 34 is elongated and positioned to extend across the base panel 12 between the speed humps 14. In the exemplary embodiment in FIGS. 6 and 7, the first cover portion 34 has a rectangular shape, though other shapes are within the scope of the disclosure. The second cover portion 36 extends transverse to the first cover portion 34 and curves downwardly over and below a front edge 38 of the base panel 12, as shown in FIG. 1. As shown in FIG. 7, the second cover portion 36 includes a recess 40 designed to receive a section of the front edge 38 of the base panel 12 to align the center cover 16 on the base panel 12. The recess 40 essentially hooks onto the base panel 12 to position the center cover 16 flush on the base panel 12. In the exemplary embodiment in FIG. 1, a top section 42 of the first cover portion 34 has a decorative design. In one possible embodiment, the top section 42 of the first cover portion 34 is removable and interchangeable with another top section 42 having a different decorative design to allow the user to alter the aesthetic of the tonneau cover assembly 10.

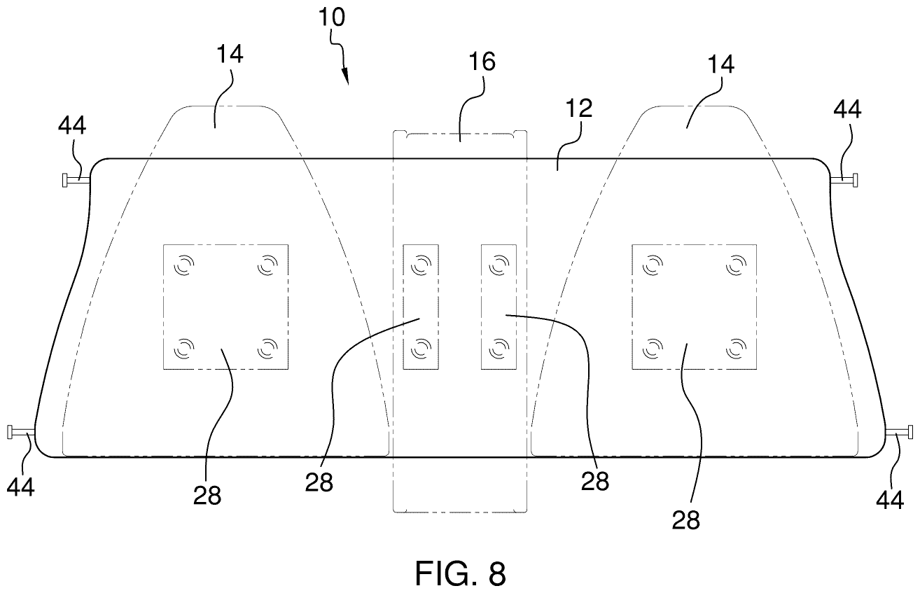

Like the bottom panel 18 of the speed humps 14, the first cover portion 34 includes a plurality of orifices 24 designed to receive connecting elements 26 to detachably couple the center cover 16 to the base panel 12, as best seen in FIG. 8. The exemplary embodiment in FIG. 3 utilizes the threaded bolts, though the center cover 16 could be connected with screws or snap fit connectors. In another possible embodiment, the rear of the center cover 16 could have a snap fit tab or similar such that the center cover 16 can snap onto the base panel 12 without the need for any connecting elements 26.

In the exemplary embodiment, the front panel 20 of each of the speed humps 14 consists of a layer of carbon fiber, though other materials could be used in another possible embodiment. Similarly, the second cover portion 36 includes a layer of carbon fiber, also positioned in the front, as shown in FIG. 3, though other materials could be used in another possible embodiment.

The base panel 12 includes four lock posts designed to be inserted into the mounting holes in the convertible 60. Such lock posts 44 are well known in the convertible 60 industry. At least one of the lock posts 44 includes a latch to detachably secure the base panel 12 in place.

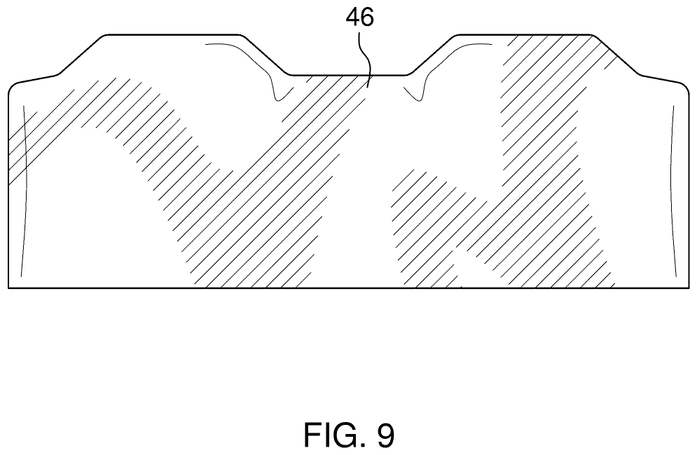

In the exemplary embodiment in FIG. 9, the tonneau cover assembly 10 further includes a slip cover 46 designed to be placed over the back seats 62. The slip cover 46 could be made of any suitable natural or synthetic materials, such as textiles, fabric, or plastic.

FIG. 2 shows the tonneau cover assembly 10 installed in the convertible 60. As can be seen, the tonneau cover assembly 10 extends from adjacent the front seats 64 over the back seats 62, but stops short of the retractable roof 66 so as to not interfere with the opening and closing of the retractable roof 66. The aerodynamic shell 22 helps with reducing drag due to wind resistance.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tonneau cover assembly for a convertible comprising:
a base panel, the base panel being configured to detachably couple to mounting holes in a convertible;
a pair of speed humps, the speed humps being coupled to the base panel, the speed humps being configured to extend over a respective one of the back seats of the convertible between a respective one of the front seats of the convertible and a retractable roof of the convertible; and
a center cover, the center cover being coupled to the base panel between the speed humps.

2. The tonneau cover assembly of claim 1, wherein the speed humps are detachably coupled to the base panel.

3. The tonneau cover assembly of claim 1, wherein:
each of the speed humps includes a bottom panel, a front panel, and an aerodynamic shell extending from the front panel and over the bottom panel; and
the aerodynamic shell is in the form of an arch extending over the front panel and the bottom panel.

4. The tonneau cover assembly of claim 3, wherein the aerodynamic shell tapers in height from a front shell portion about the front panel to a tail shell portion.

5. The tonneau cover assembly of claim 3, wherein the aerodynamic shell tapers in width from the front shell portion about the front panel to the tail shell portion.

6. The tonneau cover assembly of claim 3, wherein the front panel of each of the speed humps consists of a layer of carbon fiber.

7. The tonneau cover assembly of claim 3, wherein the bottom panel of each of the speed humps includes a plurality of orifices configured to receive connecting elements to detachably couple each of the speed humps to the base panel.

8. The tonneau cover assembly of claim 1, wherein:
the center cover includes a first cover portion and a second cover portion;
the first cover portion is elongated and positioned to extend across the base panel between the speed humps; and
the second cover portion extends transverse to the first cover portion and curves downwardly over and below a front edge of the base panel.

9. The tonneau cover assembly of claim 8, wherein the second cover portion includes a recess configured to receive a section of the front edge of the base panel to align the center cover on the base panel.

10. The tonneau cover assembly of claim 8, wherein the first cover portion includes a plurality of orifices configured to receive connecting elements to detachably couple the center cover to the base panel.

11. The tonneau cover assembly of claim 8, wherein the second cover portion includes a layer of carbon fiber.

12. The tonneau cover assembly of claim 1, wherein the base panel includes four lock posts configured to be inserted into the mounting holes in the convertible.

13. The tonneau cover assembly of claim 1, further comprising a slip cover configured to be placed over the back seats.

14. The tonneau cover assembly of claim 2, wherein:
each of the speed humps includes a bottom panel, a front panel, and an aerodynamic shell extending from the front panel and over the bottom panel; and
the aerodynamic shell is in the form of an arch extending over the front panel and the bottom panel.

15. The tonneau cover assembly of claim 14, wherein:
the aerodynamic shell tapers in height from a front shell portion about the front panel to a tail shell portion; and
the aerodynamic shell tapers in width from the front shell portion about the front panel to the tail shell portion.

16. The tonneau cover assembly of claim 15, wherein the bottom panel of each of the speed humps includes a plurality of orifices configured to receive connecting elements to detachably couple each of the speed humps to the base panel.

17. The tonneau cover assembly of claim 16, wherein:
the center cover includes a first cover portion and a second cover portion;
the first cover portion is elongated and positioned to extend across the base panel between the speed humps; and
the second cover portion extends transverse to the first cover portion and curves downwardly over and below a front edge of the base panel.

18. The tonneau cover assembly of claim 17, wherein:
the second cover portion includes a recess configured to receive a section of the front edge of the base panel to align the center cover on the base panel; and
the first cover portion includes a plurality of orifices configured to receive connecting elements to detachably couple the center cover to the base panel.

19. The tonneau cover assembly of claim 18, wherein the base panel includes four lock posts configured to be inserted into the mounting holes in the convertible.

20. The tonneau cover assembly of claim 19, further comprising a slip cover configured to be placed over the back seats.
